(19) United States
(12) Patent Application Publication
(10) Pub. No.: US 2013/0273335 A1
(43) Pub. Date: Oct. 17, 2013

(54) WALL STRUCTURE

(71) Applicant: Shawn Engberg, Kearney, NE (US)

(72) Inventor: Shawn Engberg, Kearney, NE (US)

(21) Appl. No.: 13/446,428

(22) Filed: Apr. 13, 2012

(51) Int. Cl. B32B 3/02; B32B 3/10; B32B 27/06; B32B 7/02; B32B 29/00; B32B 9/06

(52) U.S. Cl. 428/192; 428/537.5; 428/486; 428/523; 428/500; 428/215; 428/216; 428/201

(57) ABSTRACT

A stack of a plurality of thin film adhesively bonded members are removably coupled to a wall structure. A method for cleaning a wall surface is also disclosed. The method includes removing pre-placed polymer sheets from a wall surface after predetermined time intervals. The adhesive is configured to allow an exposed polymer sheet layer to be removed without removing the entire stack of rectangular members.

### FIELD

The present disclosure relates to a wall structure and, more particularly, to a structure and method of cleaning a wall surface in a clean environment such as a surgical theater or a paint room.

### BACKGROUND

The statements in this section merely provide background information related to the present disclosure and may not constitute prior art. Recent operational environments such as paint booths, electronics manufacturing environments or surgical operating theaters utilize open environments. Because of this, cleanliness, while always a priority, is a primary concern.

In commercial cleanroom type environments, the number of procedures lead to significant amounts of organic, dust, or biological materials to be expressed into the operational environment. Materials carried by these particulate often collect on the interior surfaces of the operational theater and can lead to contamination, defects in coating quality or in the case of a surgical operating theater, infections and spread of disease. Included in these surfaces is the wall which must be cleaned frequently. This regular cleaning is expensive and time consuming. In the case of ceramic wall surfaces, it may not be possible to clean the surfaces to an acceptable level, requiring the replacement of the interior surfaces.

### SUMMARY

This section provides a general summary of the disclosure, and is not a comprehensive disclosure of its full scope or all of its features.

To assist in the cleaning of the walls of a clean room type environment, a wall structure and method of cleaning a surgical wall are provided. In this regard, a wall formed of wall surfaces are covered with stacks of peel-able polymer layers. To clean the surface, an exposed layer of peel-able polymer material is removed at predetermined intervals, thus leaving a clean polymer surface.

In one embodiment of the invention, a stack of a plurality of quadrilateral members are removably coupled to the wall surface. The stack of quadrilateral members is coupled together using an adhesive. The adhesive is configured to allow an exposed layer to be removed without removing the entire stack of quadrilateral members. The quadrilateral members optionally can have less than 10% by weight remaining on an exposed surface to attract floating particulate such as dust.

In yet another embodiment, the wall structure is provided having a support structure. Coupled to the support structure is a plurality of interlocking wall engaging members; coupled to a plurality of wall engaging members is a stack of a plurality of biodegradable polymer sheets, each biodegradable sheet can be releasably coupled to at least one other sheet with an adhesive. The adhesive material is configured to allow the removal of a single layer of biodegradable material from the stack of biodegradable sheets.

In another embodiment, a method of cleaning a surface in a clean room is provided. The method includes the step of coupling a stack of adhesively bonded biodegradable sheets to a surface. After a predetermined amount of time, or upon a predetermined accumulation of material, at least one layer from the stack of biodegradable sheets is removed.

In another embodiment, an alternate method of cleaning a surface in a clean room is provided. The method includes the step of unrolling a stack of adhesively bonded sheets. After unrolling, the adhesively bonded sheets are coupled to a wall surface. After a predetermined amount of time of operation of equipment in the clean room, or upon a predetermined accumulation of material, at least one layer from the stack of biodegradable sheets is removed.

Further areas of applicability will become apparent from the description provided herein. It should be understood that the description and specific examples are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 represents a view of a wall structure according to the teaching of the present disclosure;

FIG. 2A represents a perspective view of the stack of polymer covers used in the construction of FIG. 1;

FIG. 2B represents a perspective view of a roll of polymer covers used in the construction of FIG. 1;

FIG. 3 is a side view of the polymer sheet according to another embodiment which is usable in the wall structure shown in FIG. 1;

FIGS. 4A-4C represent top views of the assembly shown in FIG. 2; and

FIG. 5 is an exploded view of the stack of polymer layers shown in FIG. 2A.

Corresponding reference numerals indicate corresponding parts throughout the several views of the drawings.

### DETAILED DESCRIPTION

Example embodiments will now be described more fully with reference to the accompanying drawings.

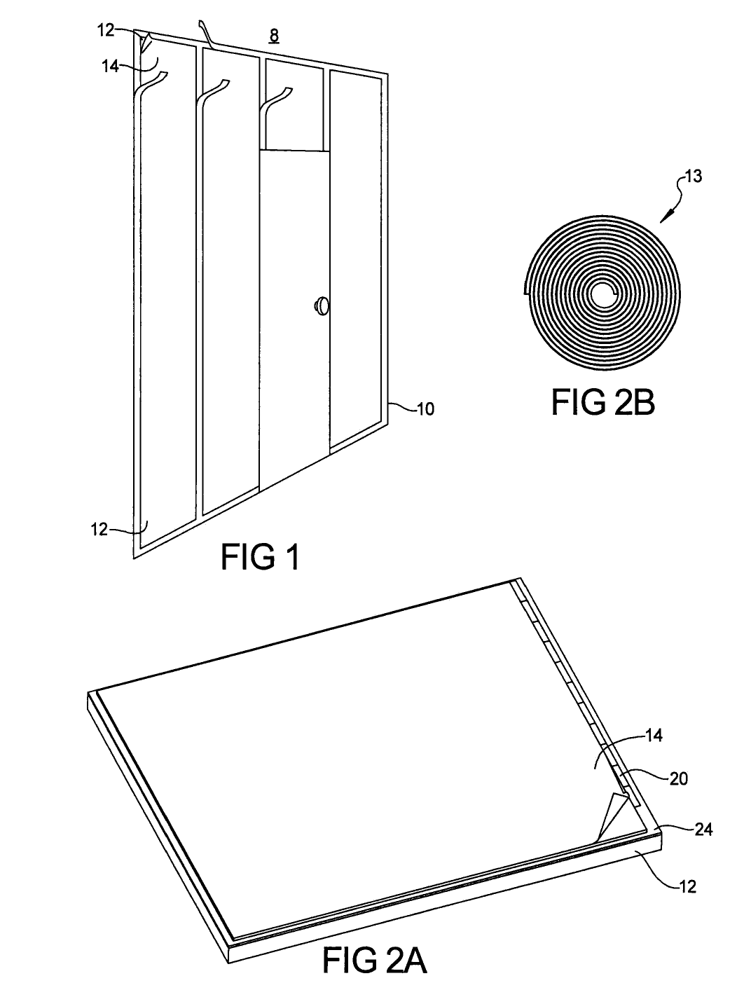

FIG. 1 represents a perspective view of a wall structure 8 according to the teaching of the present disclosure. As described further below, shown is a support structure or frame 10 which covers the interface between a stack of coating layers 14. These wall surfaces 12, can be quadrilateral such as square or rectangular and, preferably, have a smooth surface texture. Additionally, the frame 10 can also have strips of layers of polymer applied thereto.

Disposed on the wall surface 12 is a stack of polymer sheets 14. The sheets 14, (see FIG. 2A), are coupled together with adhesive 16 in a manner which allows the removal of a single layer of the polymer sheets 14. It is envisioned the adhesive 16 can be disposed between the layers at the periphery 18 of the polymer sheets 14. The adhesive material can be from 0.5 to 2.5, and, preferably, 2.0 mils thick. This adhesive can be configured to allow the top sheet to be selectively removed from the stack of sheets with the application of between about 45 oz/in and 24 oz/in of force. The adhesive is configured to resist delamination caused by gravity under a temperature up to about 200° F. Similarly, the adhesive is configured to resist delamination caused by gravity and humidity of up to about 100% humidity.

The sheets 14, (see FIG. 2B), can be rolled to facilitate shipment. The inner layers are coupled together with adhesive 16 in a manner which allows the removal of a single layer of the polymer sheets 14. It is envisioned the adhesive 16 can be disposed between the layers at the periphery 18 of the polymer sheets 14. When rolled, the outer layer can be non-stick to allow the material to be unrolled. It is envisioned that the rolled material can be held onto the wall using adhesive, or optionally, coupled to the wall with fasteners which are passed through the stack of material. The stack can have a plurality of preformed weakened spots at predetermined locations to facilitate the passing of a fastener there through. The adhesive can be configured to allow the top sheet to be selectively removed from the stack of sheets with the application of between about 45 oz/in and 24 oz/in of force. The adhesive is configured to resist delamination caused by gravity under a temperature up to about 200° F. Similarly, the adhesive is configured to resist delamination caused by gravity and humidity of up to about 100% humidity.

Should the polymer sheets be used in a paint booth, the adhesive must be capable of non-degradation in the presence of solvents used with the paint being applied. These solvents can be for example water for water born paint or a petroleum distillate. The polymer sheet can be specifically configured to attract paint on the exposed surface. Optionally, each of the layers can be placed onto a charged surface to attract charged paint particles such as used in an ELPO or electro depositions paint process. Optionally, the polymer sheets can incorporate material such as carbon black to facilitate the application of an electrical charge to attract charged paint particles.

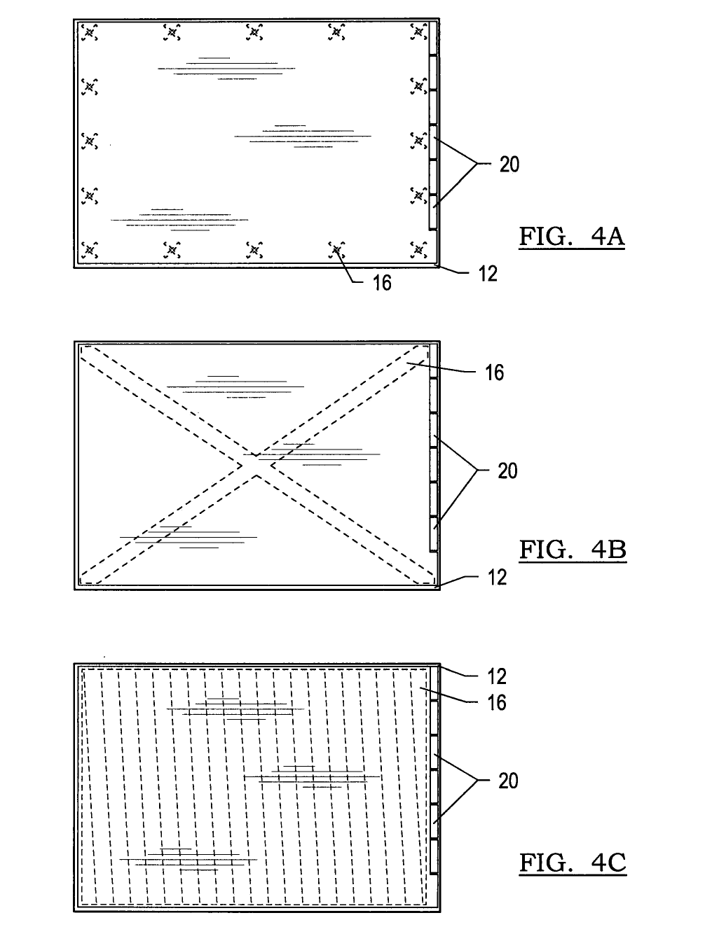

As shown in FIGS. 2A, 2B and 4A-4C, the stack of polymer sheets 14 each can have pull-able tabs 20 generally located at the interface of the sheets with adjacent side walls to facilitate the removal of the polymer sheets 14. For rolled material, (see FIG. 2B) the tabs can be places at even intervals, e.g., 4 foot, which allow the tabs to be found when the material has been cut to size. These pull-able tabs 20 can be overlapping or can be staggered to allow access to the tabs when the stack of polymer sheets are coupled to the wall surface. It is preferable that more than (90%) of the adhesive be attached to the removed sheet of polymer material 14. For the single layer of adhesive disposed between the stack of sheets and the wall surface, the adhesive preferably is of a higher strength to hold the stack of material to the wall surface.

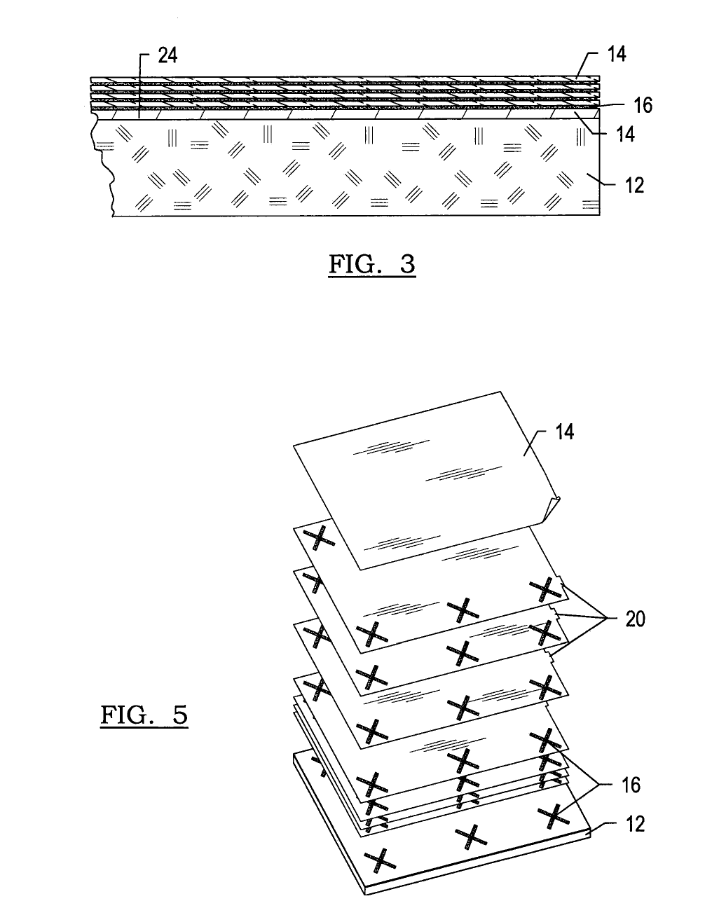

As best seen in FIG. 3, the wall surface 12 has a stack of polymer sheets 14. In the preferred configuration, approximately twelve polymer sheets are applied to a visible surface 24 of the wall surface 12. The polymer and adhesive preferably are formed of a microbial resistant material. In this regard, the polymer material can be formed of paper, waxed paper, polypropylene, acrylic and coated. Optionally, the film can be formed of bio-resistant material. In this regard, it is envisioned the bio-resistant material can be a bi-phase material containing an antimicrobial additive, a lubricant, and a thermal stabilizer. These layers can have a colored and smooth exterior surface therein or thereon to show the presence of dirt or biological growth. Optionally, the material can incorporate copper into the adhesive or the polymer material.

The material for the polymer film is between 0.5 and 2 mm thick and preferably between 0.5 and 1 mm thick. As best can be seen in FIGS. 4A-4C, the adhesive 16 can be distributed over the polymer sheets using varying configurations. In this regard, the adhesive 16 can be formed in x patterns around the periphery 18 of the polymer sheet 14. Additionally, the adhesive can be distributed across the sheet in an x pattern or in stripes or strips over the entire sheet. When it is the intention for the material to collect airborne materials, the adhesive can be evenly distributed across the face of the material.

The stack of polymer sheets can weigh less than 5 ounces. The stack of polymer sheets can also be coupled either to the support structure or the wall surfaces. To prepare a surface for cleaning under the present teachings, a stack of polymer layers are coupled to a wall structure. After a desired or predetermined amount of time or the accumulation of an undesirable amount of material, the outermost polymer layer can be removed from the stack of polymer layers.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A wall structure comprising:
a wall surface having a bearing surface; and
a stack of biodegradable polymer sheets coupled to a wall surface, each biodegradable sheet being coupled to an adjacent biodegradable polymer sheet by a layer of adhesive and separable therefrom by the application of between 45 oz/in and 24 oz/in of force.

2. The wall structure according to claim 1 comprising a biodegradable adhesive disposed between the polymer sheets.

3. The wall structure according to claim 3 wherein the polymer sheets comprise an antimicrobial agent.

4. The wall structure according a claim 3 wherein the polymer sheet has a thickness of between 0.5 mm and 2 mm.

5. The wall structure according to claim 1 wherein the stack of polymer sheets is coupled to a plurality of wall surfaces.

6. The wall structure according to claim 1 wherein the stack of polymer sheets is coupled to the support structure.

7. A wall structure comprising:
a support structure having a first coupling mechanism;
a wall layer coupled to the first coupling mechanism support structure; and
a stack of polymer layers coupled to the wall layer, each polymer layer being coupled to an adjacent polymer layer by a layer of adhesive.

8. The wall structure according to claim 7 wherein the wall layer is a wall surface.

9. The wall structure according to claim 7 wherein the stack of polymer materials comprises an antimicrobial.

10. The wall structure according to claim 7 wherein the stack of polymer layers comprise a plurality of polymer sheets, each less than about 2 mils thick.

11. The wall structure according to claim 10 wherein each of the polymer layers comprises a tab.

12. The wall structure according to claim 10 further comprising an antimicrobial between the polymer layers.

13. The wall structure according to claim 11 wherein the adhesive layer in disposed about the periphery of the polymer layer.

14. The wall structure according to claim 11 wherein the antimicrobial layer is evenly disposed over a portion of the polymer layer.

15. The wall structure according to claim 11 wherein the adhesive layer is formed in stripes.

16. A wall structure comprising:
a support structure;
a wall surface coupled to the support structure; and
a stack of thin film polymer material layers coupled to the support structure; and a layer of adhesive having an antimicrobial layer between the thin film polymer material layers.

17. The wall structure according to claim 16 wherein the stack of polymer materials are formed with a holding strength between 24 oz/in and 45 oz/in.

18. The wall structure according to claim 16 wherein the stack of thin film polymer material layers comprise a plurality of polymer sheets, each less than 2 mm thick.

19. The wall structure according to claim 18 wherein each of the polymer sheets comprises a tab.

20. The wall structure according to claim 18 wherein one of the wall layer or polymer sheets is electrically conductive.
